(19) United States
(12) Patent Application Publication
(10) Pub. No.: US 2014/0170333 A1
(43) Pub. Date: Jun. 19, 2014

(54) MICRO-AND NANO-FABRICATION OF CONNECTED AND DISCONNECTED METALLIC STRUCTURES IN THREE-DIMENSIONS USING ULTRAFAST LASER PULSES

(71) Applicants: Eric Mazur, Concord, MA (US); Kevin L. Vora, Cambridge, MA (US); SeungYeon Kang, Cambridge, MA (US)

(72) Inventors: Eric Mazur, Concord, MA (US); Kevin L. Vora, Cambridge, MA (US); SeungYeon Kang, Cambridge, MA (US)

(73) Assignee: President & Fellows of Harvard College, Cambridge, MA (US)

(21) Appl. No.: 13/978,005

(22) PCT Filed: Jan. 20, 2012
(86) PCT No.: PCT/US12/22036

§ 371 Date: Oct. 31, 2013

Related U.S. Application Data
(60) Provisional application No. 61/434,997, filed on Jan. 21, 2011.

(51) Int. Cl. B05D 3/06

(52) U.S. Cl. CPC B05D 3/06
USPC 427/555

(57) ABSTRACT

In one aspect, a method for fabricating metal structures in two or three dimensions is disclosed, which includes providing a mixture of a polymer, a metal precursor and a solvent, and applying the mixture to a surface of a substrate. The applied mixture can then be cured (e.g., via a heat treatment) to generate a polymeric layer (e.g., a polymeric film) with ions associated with the metal precursor distributed therein. Subsequently, radiation (e.g., radiation pulses) at a wavelength to which the polymeric layer is substantially transparent is focused onto at least one location of the polymeric layer so as to cause chemical reduction of metal ions associated with the metal precursor within at least a portion of that location, thereby generating at least one metalized region.

### RELATED APPLICATION

The present application claims priority to a provisional application filed on Jan. 21, 2011 and having a Ser. No. 61/434,997. This provisional application is herein incorporated by reference in its entirety.

### STATEMENT OF GOVERNMENT SUPPORT

This invention was made with government support under FA9550-08-1-0285 awarded by the U.S. Air Force Office of Scientific Research. The government has certain rights in the invention.

### BACKGROUND

The present disclosure relates generally to methods and systems for generating metalized structures (e.g., connected and disconnected micro- and nano-sized structures) in a support matrix, e.g., a polymeric substrate, and to such a metalized support matrix having a plurality of metalized structures distributed therein.

Current techniques for fabricating micro- and nano-sized metallic structures in a substrate suffer from a number of shortcomings. For example, only a few of such conventional techniques allow direct patterning of metal structures, and even fewer allow patterning of metal structures in three dimensions. Further, the conventional techniques that allow three-dimensional patterning of metal structures are generally time-consuming, and can typically be used only for generating connected metal structures. For example, one conventional method for creating three dimensional (3D) metal structures includes depositing metal on polymer patterns generated by direct laser writing, e.g., by coating 3D polymer structures or by filling contiguous volumetric voids. However, the types of metal structures that can be created by such an approach are limited.

Accordingly, there is a need for methods and systems for fabricating metal structures in substrates, and particularly, there is a need for such methods and systems that allow direct, and fast fabrication of both connected and disconnected three-dimensional metal structures.

### SUMMARY

In one aspect, the present invention provides methods for fabricating metal structures (e.g., silver and gold structures), which can have tunable dimensions. In some embodiments, ultrafast laser radiation is employed for direct-writing of such metal structures in a substrate, e.g., a polymeric substrate. In many embodiments, nonlinear optical interactions between one or more chemical precursors and femtosecond pulses are utilized to limit photoreduction processes to focused spots, where in some cases the interaction volume can be smaller than the diffraction limit. In this way, in some embodiments, metal nanostructures can be created in a focal volume, which can be rapidly scanned in three dimensions (3D). In some embodiments, by varying the solution chemistry and laser pulse parameters, morphological control of the resulting structures can be obtained. By way of example, metal grid and woodpile patterns can be produced, e.g., over hundreds of micrometers in dimensions. Further, the process can be scalable and can have a variety of applications, such as SERS (surface enhanced Raman spectroscopy) and metamaterials. In some embodiments, the methods of the invention allow generating metal structures with submicron resolution (e.g., a resolution in a range of about 100 nm to about 300 nm). As discussed in more detail below, in some embodiments, metal (e.g., silver) structures, for example, disconnected metal structures, can be generated in 3D at writing speeds up to about 200 μm/sec (micrometers (microns) per second). In some embodiments, the metal structures, e.g., silver structures, can be grown inside a polymer support matrix, enabling formation of arbitrary 3D disconnected metal structures, e.g., with submicrometer resolution. In some embodiments, the metal features can be generated at a writing speed (e.g., the speed at which the focal volume is scanned) in a range of about 1 to about 200 μm/sec.

In one aspect, a method for fabricating metal structures is disclosed, which includes providing a mixture of at least one compound (e.g., one or more monomers or one or more polymers), at least one metal precursor and at least one solvent, and applying the mixture to a surface of a substrate. The applied mixture can be cured (e.g., via a heat treatment), e.g., to increase the viscosity of the mixture to generate a cured mixture, e.g., a polymeric matrix in which metal precursor and/or ions associated with the metal precursor are distributed. Subsequently, radiation (e.g., radiation pulses) is focused onto at least one location of the cured mixture (e.g., a polymeric layer generated by curing the mixture) so as to form at least one metal structure within at least a portion of said location. The cured mixture can include a plurality of metal ions associated with the metal precursor (e.g., an ionic form of a metal constituent of the metal precursor) and the focused radiation can cause chemical reduction of at least a portion of the metal ions within at least a portion of the location into which the radiation (e.g., radiation pulses) is focused, thereby fabricating a metalized region (structure). For example, the focused radiation can have a sufficiently high intensity within the location into which it is focused so as to undergo non-linear absorption by at least one radiation absorbing constituent of the cured mixture, thereby mediating the reduction of at least a portion of the metal ions in that location. In some embodiments, the applied radiation has a wavelength to which the cured mixture (e.g., the polymer layer) is substantially transparent. For example, the cured mixture can exhibit no allowed electronic transitions at the energy of the applied radiation.

In some embodiments, the curing of the mixture (e.g., by heating the mixture at an elevated temperature, such as a temperature in a range of about 40° C. to about 120° C.) can cause a portion of the metal precursor to form metal nanoparticles, which can function as seed particles for generating metalized structures in the subsequent step of irradiating the cured mixture. The nanoparticles can have a size in each dimension (e.g., in each of x, y, and z Cartesian dimensions) that is in a range of about 2 nm to about 20 nm, and preferably in a range of about 2 nm to about 10 nm, e.g., in a range of about 5 nm to about 10 nm.

Further, in some embodiments, seed metallic nanoparticles can be added to the mixture to facilitate the formation of the metalized structures in the subsequent steps. For example, in addition to the metal precursor (e.g., a metal salt), the mixture can include metal nanoparticles (e.g., nanoparticles of gold or silver), which can function as seed particles for formation of metalized structures. In many embodiments, these seed metal nanoparticles can have a size in each dimension that is in a range of about 2 nm to about 100 nm, and preferably in a range of about 2 nm to about 20 nm, e.g., in a range of about 5 nm to about 20 nm.

As noted above, the focused radiation can have a sufficiently high intensity within at least a portion of the location onto which it is focused so as to be absorbed via non-linear processes (e.g., multi-photon absorption) by one or more constituents (moieties) of the cured mixture, which can be a polymeric layer, thereby mediating the chemical reduction of the metal precursor. By way of example, such constituents (moieties) can be residual solvent, or nanoparticles, or polymer in the mixture, etc. In general, the radiation intensity and/or fluence that can mediate the reduction of metal ions associated with the metal precursor can depend on a variety of factors, such as, the type of the polymer, whether any degradation of the polymeric film has occurred, e.g., due to exposure to ambient light, the presence of seeding nanoparticles, etc. For example, in some embodiments, the radiation fluence can be as small as about 20 J/m² (e.g., about 20.7 J/m² or greater) and/or the pulse energy can be as small as about 0.07 nJ. In some embodiments, the radiation intensity at the focal volume associated with a radiation pulses applied to the cured mixture can be in a range of about 4×10¹² W/m² to about 2×10¹⁵ W/m².

The mixture can be applied to the substrate surface by employing a variety of techniques, such as pouring the mixture onto the substrate surface, dip-coating or spin-casting. In some embodiments, the polymeric layer generated by the curing step can be in the form of a polymeric film having a thickness, e.g., in a range of about 0.5 micrometers (microns) to about 50 micrometers, e.g., in a range of about 0.5 micrometers to about 20 micrometers.

The step of curing the applied mixture can be performed in a variety of ways. For example, the applied mixture can be heated at an elevated temperature for a selected duration, e.g., by placing the mixture-coated substrate in an oven. By way of example, the applied mixture can be cured to form a polymeric matrix by exposing it to a temperature in a range of about 40° C. to about 150° C., e.g., in a range of about 50° C. to about 100° C., for a duration in a range of about 30 minutes to about 24 hours. For example, the applied mixture can be cured at these temperatures to form a more viscous or solid polymeric matrix.

As noted above, one or more locations of the cured mixture (e.g., a polymeric layer) can be exposed to radiation (e.g., radiation pulses) to cause chemical reduction of metal ions associated with the metal precursor in at least a portion of those locations. In some embodiments, the applied radiation comprises a plurality of radiation pulses having a pulsewidth, e.g., in a range of about 5 femtoseconds (fs) to about 100 nanoseconds (ns). In some embodiments, the radiation pulses can have a pulsewidth in a range of about 10 fs to about 1 picosecond (ps), e.g., in a range of about 10 fs to about 500 fs. Further, in some embodiments, the pulses applied to the polymeric matrix can have an energy in a range of about 0.07 nanojoules (nJ) to about 40 nJ (e.g., in a range of about 0.1 nJ to about 10 nJ). In some cases, the number of radiation pulses applied to the location into which the pulses are focused can be in a range of 1 to about 1 million (e.g., in range of 1 to about 100,000, or in a range of 1 to about 10,000, or in a range of 1 to about 1000 or in a range of 1 to about 500). In some embodiments, the radiation can be focused into the cured mixture (e.g., a polymeric layer) with a numerical aperture in a range of about 0.4 to about 1.5.

In some embodiments, the radiation can have a wavelength (e.g., a central wavelength when the radiation is in the form of pulses) in a range of about 500 nanometers (nm) to about 1200 nm, e.g., in a range of about 525 nm to about 1050 nm, such as 800 nm.

A variety of polymers, metal precursors, solvents and substrates can be utilized. For example, the polymer can be, without limitation, polyvinyl pyrrolidone (PVP), polyvinyl alcohol (PVA), polyvinylcarbazole (PVK), polymethylmethacrylate (PMMA), polystyrene (PS), among others.

A variety of metal precursors can be employed. In some embodiments, the metal precursor can be a metal salt, e.g., nitrate, halide or chlorate salts of metals. For example, a variety of silver salts, such as AgNO₃, AlClO₄, AgBF₄, among others, can be utilized to fabricate silver structures. In some embodiments, the silver structures are in the form of crystalline silver. As another example, HAuCl₄ can be employed to fabricate gold structures.

Further, a variety of solvents can be employed. Some examples of suitable solvents include, without limitation, water (e.g., distilled water), an alcohol, e.g., ethanol, and ethylene glycol.

In some embodiments, the cured mixture can be substantially free of a constituent that can cause reduction of the metal ions associated with metal precursor in absence of the applied radiation.

In some embodiments, a mixture of a metal precursor, a polymer and a solvent is employed to generate a metal-doped polymeric matrix, e.g., by curing the mixture as discussed above, where the solvent is slow in reducing the metal ions in the metal-doped matrix in regions of the polymeric matrix outside the focal volumes of the applied radiation pulses or is incapable of reducing the metal ions in those regions. For example, in some embodiments, the solvent does not cause any significant reduction of the metal ions associated with the metal precursor (e.g., a reduction of at least about 50% of the ions present in the metal-doped polymer) in absence of the applied radiation even after passage of a few days, or a few weeks, or a few months. In this manner, metal structures can be generated with an enhanced spatial selectivity. By way of example, in some embodiments, the solvent is free of any alcohol. For example, in some embodiments, the mixture can include a metal precursor (e.g., AgNO₃), a polymer (e.g., PVP), and water, while lacking any alcohol constituent.

In some embodiments, the polymer can be selected so as to modulate the reducing action of the solvent on the metal ions associated with the metal precursor. By way of example, in some embodiments, the polymer can inhibit the growth of metal particles generated via reduction of the metal ions by the solvent in the metal-doped polymer beyond a certain limit. For example, in some embodiments, PVP can be employed to modulate the reducing action of the solvent, e.g., water.

In some embodiments, the metalized structures can be in the form of two-dimensional or three-dimensional metalized regions that are separated from one another by unmetalized regions (the unmetalized regions refer to those regions in which the metal precursor and/or ions associated with the metal precursor have not undergone a chemical reduction reaction) of the cured mixture, which can be a polymeric layer. Alternatively, the metallic structures can form interconnected two-dimensional or three-dimensional metal structures.

In some embodiments, the methods of the invention can be employed to fabricate disconnected three-dimensional metal structures (regions) within a polymeric matrix, where each metal structure has a size in at least one dimension (and in some cases, in each of three dimensions, e.g., x, y, and z Cartesian dimensions) that is less than about 5 micrometers, e.g., in a range of about 100 nm to about 5 micrometers (e.g., in a range of about 150 nm to about 3 micrometers), or in a range of about 300 nm to about 3 micrometers.

In some embodiments, the metalized structures are formed within the cured mixture (e.g., a polymeric layer) according to a predefined pattern (e.g., a two-dimensional or a three-dimensional pattern). For example, the substrate on which the polymeric layer is disposed can be mounted on a translation platform that is movable in three dimensions in response to control signals from a controller. The controller can move the platform and consequently the substrate, and can further control the application of the radiation to the cured mixture (e.g., a polymeric layer (film)) so as to ensure that selected locations of the polymeric layer are exposed to the radiation. For example, these locations can be distributed within a two-dimensional or a three-dimensional extent of the polymeric layer. Alternatively, the substrate can be fixed and the radiation can be scanned in two or three dimensions to form a desired pattern. The metal structures can have at least one of their dimensions extended to be as large as 100 micrometers, or 1 millimeter or larger by relative motion of the radiation and the cured mixture (e.g., a polymeric layer), e.g., by continuously translating the substrate on which the cured mixture is disposed relative to the radiation or by scanning the radiation over the cured mixture or both.

In further aspects, a method of generating metal structures is disclosed, which comprises generating a polymeric matrix having a plurality of metal ions distributed therein, and focusing at least one radiation pulse (e.g., a laser pulse) onto at least one location of the polymeric matrix so as to cause at least a portion of the metal ions within said location to form one or more metal structures. The radiation pulse(s) can cause reduction of at least a portion of the metal ions so as to form said one or more metal structures. For example, the radiation pulse(s) can be non-linearly absorbed by at least one constituent of the polymeric matrix, thereby mediating the reduction of the metal ions. In some embodiments, the metal-doped polymeric matrix can be formed by generating a mixture of a polymer, a metal precursor and a solvent, and curing the mixture, e.g., via heating the mixture. In some embodiments, the mixture can be applied to a substrate, such as a glass substrate, and then cured to form a metal-doped polymeric layer. A variety of polymers, metal precursors, and solvents, such as those discussed above, can be employed to form the mixture. Some examples of polymers include, without limitation, polyvinyl pyrrolidone, polyvinyl alcohol, polyvinyl carbazole, polymethylmethacrylate, and polystyrene. In some embodiments, the polymeric matrix is free of a constituent capable of reducing said metal ions in absence of the radiation pulses. By way of example, in some embodiments, the polymeric matrix can be formed of PVP and can be free of an alcohol constituent. In some embodiments, the radiation pulses can have a pulsewidth in a range of about 5 fs to about 100 ns and a fluence in a range of about 0.5 J/m² to about 500 J/m² in locations into which the pulses are focused. The radiation pulses can have a central wavelength to which polymeric matrix is substantially transparent in absence of non-linear absorption.

In further aspects, a method of generating metal structures is disclosed, which comprises applying an aqueous solution of a polymer and a metal precursor to a substrate surface, curing the applied solution so as to generate a polymeric matrix, and focusing one or more pulses of radiation into at least one three-dimensional region of the polymeric matrix so as to metalize at least a portion of said three-dimensional region. The metallization can occur via reduction of metal ions associated with the metal precursor, where the reduction can be mediated via non-linear absorption of the radiation by one or more constituents of the polymeric matrix. In some embodiments, the aqueous solution is free of any alcohol. In some embodiments, the radiation pulses can have a pulsewidth in a range of about 5 fs to about 100 ns, e.g., in a range of about 5 fs to about 1 ps, and a pulse energy in a range of about 0.05 nJ to about 40 nJ. A variety of polymers and solvents, such as those discussed above, can be employed. By way of example, in some embodiments, the aqueous solution can be formed by dissolving PVP in water. In some embodiments, such an aqueous solution, does not include any alcohol.

In further aspects, a method of generating metal structures is disclosed, which comprises generating a polymeric matrix over a substrate surface, said polymeric matrix having a metal precursor distributed therein, and focusing radiation onto at least one location of the polymeric matrix so as to cause chemical reduction of at least a portion of ions associated with the metal precursor within at least a portion of said location, thereby generating a metalized structure. The focused radiation can have a sufficiently high intensity at said location so as to undergo non-linear absorption by at least one radiation-absorbing constituent of said polymeric matrix, thereby mediating the chemical reduction of the metal ions.

In some embodiments, the radiation pulses employed to cause selective reduction of the metal ions in the polymeric matrix can have a pulsewidth in a range of about 5 femtoseconds to about 100 nanoseconds, e.g., in a range of about 5 femtoseconds to about 1 picosecond, or in a range of about 5 femtoseconds to about 500 femtoseconds; an energy in a range of about 0.05 nJ to about 40 nJ, e.g., in a range of about 0.1 nJ to about 20 nJ, or in a range of about 0.1 nJ to about 10 nJ. In some embodiments, the radiation pulses can be focused into a focal volume within the polymeric matrix such that the radiation fluence within at least a portion of the focal volume can be in a range of about 0.5 J/m² to about 500 J/m², e.g., in a range of about 1 J/m² to about 100 J/m², or in a range of about 10 to about 100 J/m².

In another aspect, a metalized substrate is disclosed that includes a polymeric matrix (e.g., a flexible polymeric matrix) and a plurality of metalized structures that are distributed, e.g., according to a predefined two-dimensional or three-dimensional pattern, within the matrix. In some embodiments, at least some of the metalized structures are separated from one another by unmetalized portions of the polymeric matrix.

Further understanding of the invention can be obtained by reference to the following detailed description in conjunction with the associated drawings, which are described briefly below.

### BRIEF DESCRIPTION OF DRAWINGS

FIG. 1 illustrates a flowchart of one exemplary method of generating metallic structures according to the teachings of the invention;

FIG. 2A is a schematic view of a substrate with a polymeric mixture disposed on a surface thereof;

FIG. 2B is a schematic view of the substrate and polymeric mixture of FIG. 2A after curing of the mixture, e.g., via a heat treatment, to form a polymeric layer;

FIG. 2C is a schematic view of radiation being applied to selected locations of the polymeric layer shown in FIG. 2B;

FIG. 3 is a schematic view of a polymeric layer of FIG. 2B having a plurality of metallic structures distributed therein;

FIG. 4 is a schematic view of a focal volume of a radiation beam focused into the polymeric layer;

FIG. 5 is a perspective schematic view of a polymeric film with a network of interconnected metallic structures formed therein disposed on a substrate;

FIG. 6A is a perspective schematic view of a stand-alone metalized polymeric substrate fabricated in accordance with the teachings of the invention;

FIG. 6B is a perspective schematic view of a stand-alone metalized polymeric substrate fabricated in accordance with the teachings of the invention, which exhibits mechanical flexibility;

FIG. 7 is a schematic view of one exemplary system for performing metallization methods according to the teachings of the invention;

FIG. 8 schematically depicts a system utilized for generating silver structures in a metal-doped polymeric matrix in accordance with an embodiment of the invention

FIG. 9A is an optical microscope image of a polymeric film with metalized regions formed therein;

FIG. 9B is an optical microscope image of the same polymeric film as that shown in FIG. 9A, but taken with a focal length different than the focal length associated with the image of FIG. 9A;

FIG. 10 is an energy-dispersive X-ray spectroscopy spectrum of a substrate on which a metalized polymeric layer formed according to the teachings of the invention is disposed;

FIGS. 11A-11C are 3D renderings of a stack of sequential 2D in-situ bright-field optical images of silver structures formed according to the teachings of the invention;

FIG. 12A is a scanning electron microscope image of an array of silver dots fabricated on a glass substrate according to the teachings of the invention;

FIG. 12B is a high resolution energy dispersion x-ray spectroscopy image of the array of silver dots shown in FIG. 12A;

FIG. 12C is a close-up image taken head-on of an individual silver dot formed according to the teachings of the invention;

FIG. 12D is a close-up image taken at a 61° tilt angle of an individual silver dot formed according to the teachings of the invention;

FIG. 13 is a plot of ultraviolet and visible micro-absorption and scattering spectroscopy data showing a silver surface plasmon peak centered around 425 nm; and

FIG. 14 is a transmission electron microscopy image of silver nanoparticles formed according to the teachings of the invention.

### DETAILED DESCRIPTION

The present disclosure relates generally to methods and systems for generating metalized structures (regions) in a substrate, e.g., a polymeric substrate, and to such substrates having a plurality of metalized structures (regions) distributed therein. As discussed in more detail below, in many embodiments, short laser pulses are focused into selected locations within a polymeric substrate having a plurality of metal ions distributed therein so as to cause chemical reduction of at least a portion of the metal ions, thereby generating metalized regions in at least a portion of those locations.

In many embodiments, the polymeric substrate can be substantially transparent to the wavelength of the applied radiation. However, the focusing of the radiation into the selected locations can result in a radiation intensity within at least a portion of those locations, e.g., at the focal volume, that is sufficiently high such that the radiation is absorbed via non-linear processes, e.g., via multi-photon absorption, by one or more constituent(s) of the polymeric substrate. Without being limited to a particular theory, such non-linear absorption of the radiation can in turn facilitate the chemical reduction of the metal ions, e.g., by facilitating charge transfer from the radiation-absorbing constituent to the metal ions. In some embodiments, the metalized structures can be separated from one another by unmetalized portions of the polymeric substrate. In other words, in some cases, the metalized structures can be distributed within the polymeric material as disconnected three-dimensional metalized regions. In other cases, the metal structures can form interconnected metalized regions within the polymeric material.

The term “compound” is used herein consistent with its common meaning in the art to refer to substance composed of atoms or ions of two or more elements in chemical combination. The atoms or ions can be united by covalent, and/or ionic bonds, or van-der-waals forces.

The term “monomer” is used herein consistent with its common meaning in the art to refer to a molecule or compound, usually containing carbon and of relatively low molecule weight, that is capable of conversion to polymers, synthetic resins, or elastomers by combination with itself or other similar molecules or compounds.

The term “polymer” is used herein consistent with its common meaning in the art to refer to a macromolecule formed by the chemical union of five or more repeating chemical units, e.g., by repeating monomers.

The term “nanoparticle” is used herein to refer to a material structure whose size in any dimension (e.g., x, y, and z Cartesian dimensions) is less than about 1 micrometer (micron), e.g., less than about 500 nm, or less than about 100 nm, e.g., in a range of about 2 nm to about 20 nm. A nanoparticle can have a variety of geometrical shapes, e.g., spherical, ellipsoidal, etc. The term “nanoparticles” is used as the plural of the term “nanoparticle.”

The terms “chemical reduction” and “reduction” are used herein consistent with the use of these terms in the art to refer to a chemical reaction in which a chemical species decreases its oxidation number, typically by gaining one or more electrons. The term “photoreduction” as used herein refers to a chemical reduction that is mediated by photons.

The term “substantially transparent,” as used herein for describing a material, is intended to mean that the linear absorption coefficient of the material for a radiation wavelength is less than about 25%, and preferably less than about 5%. In other words, radiation having that wavelength can penetrate into the material without much absorption by the material. As discussed below, such radiation can be used, e.g., for fabricating three-dimensional metallic patterns.

The term “short radiation pulses,” as used herein, refers to pulses of electromagnetic radiation having a temporal duration in a range of about 10 femtoseconds (fs) to about a few hundred nanoseconds (ns) (e.g., 500 ns).

The term “focal volume” is used herein consistent with its common meaning in the art to refer to a volume extended axially about a focal plane, a plane at which a focused radiation beam exhibits a minimum beam waist and a maximum intensity, up to a plane at which the beam exhibits a beam waist that is larger than the minimum beam waist by a factor of about \sqrt{2}.

Without being limited to a particular theory, in many embodiments, the contact of the metal precursor with the solvent results in generating ionic species associated with the constituents of the metal precursor, including metal ions, where at least a portion of the metal ions remains in the cured mixture to form, e.g., a polymer matrix doped with a plurality of metal ions.

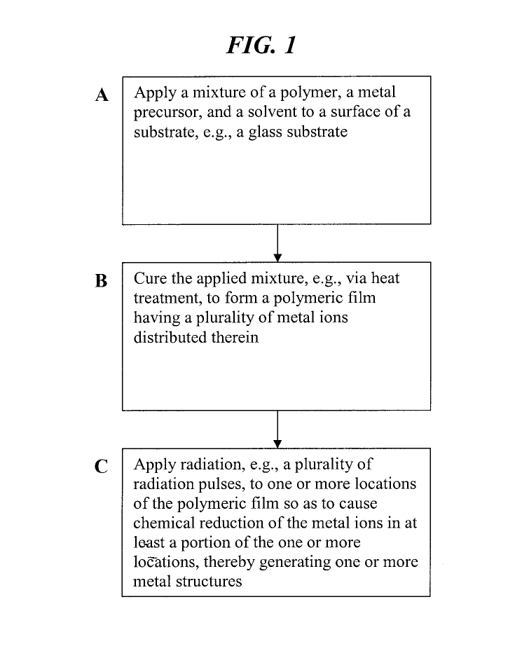

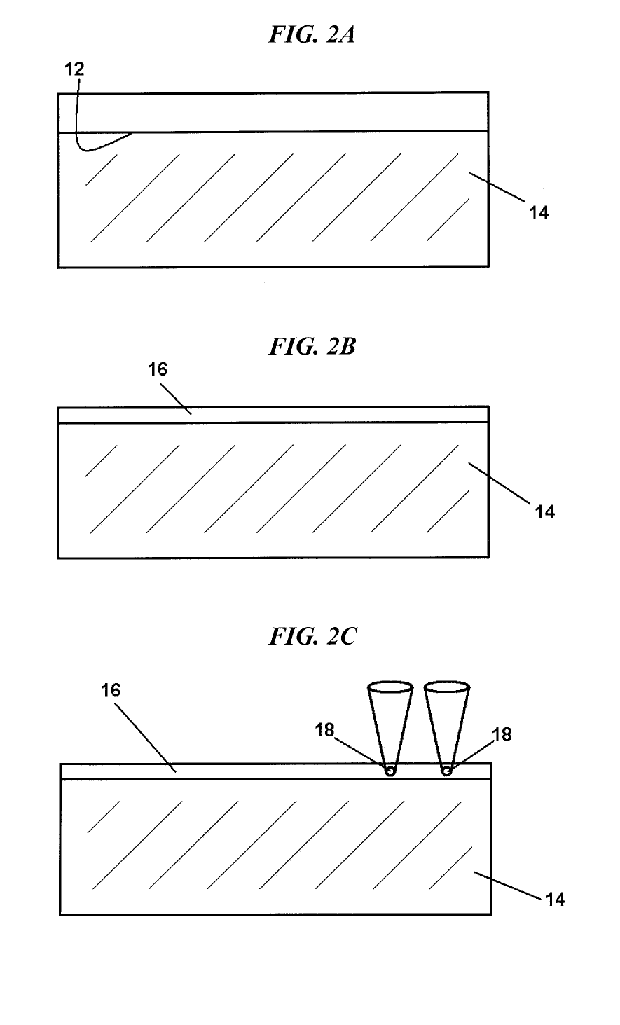

With reference to flow chart of FIG. 1 as well as FIGS. 2A, 2B, and 2C, in an exemplary embodiment of a method for generating metal structures, a mixture of a polymer, a metal precursor, and a solvent is applied to a surface 12 of a substrate 14 (step A). By way of example, the mixture can be in the form of a solution or a colloid. For example, as discussed in more detail below, in some cases the solvent can be water and the mixture can be in the form of an aqueous solution. A variety of techniques known in the art can be employed to apply the mixture to the substrate surface. For example, the mixture can be applied to the substrate surface by pouring the mixture onto the surface or by dipping the substrate into the mixture. In some cases, spin-casting can be employed to obtain a thin layer of the mixture over the substrate surface. In some embodiments, the substrate surface is treated, e.g., via plasma treatment and/or salinization, prior to the application of the mixture thereto. For example, in some embodiments, the substrate surface (e.g., the surface of a glass substrate) can be treated with a variety of silanes, such as Acryloxy Propyl Methoxy Silane (APMS) or Mercapto Propyl Trimethoxy Silane.

Further, a variety of substrates can be employed. Some examples of suitable substrates include, without limitation, glass, polymer or other organics, and semiconductor substrates (e.g., silicon). In many embodiments, the substrate surface to which the mixture is applied is preferably flat.

In some embodiments, the mixture of the polymer, the metal precursor, and the solvent is an aqueous solution formed by dissolving the polymer and the metal precursor in water. In other cases, the mixture can be formed by dissolving the polymer and the metal precursor in an organic solvent, such as an alcohol.

Generally, a variety of polymers, metal precursors, and solvents can be employed. In some embodiments, metal salts can be utilized as the metal precursor. For example, a variety of silver salts, such as AgNO₃, AlClO₄, AgBF₄, among others, can be utilized to generate silver structures. As another example, HAuCl₄ can be employed to generate gold structures.

Further, a variety of polymers can be employed in the practice of the invention. Some examples of suitable polymers include, without limitation, polyvinyl pyrrolidone (PVP), polyvinyl alcohol (PVA), polyvinylcarbazole (PVK), polymethylmethacrylate (PMMA), polystyrene (PS), among others.

Moreover, a variety of solvents can be utilized to form the mixture. Some examples of suitable solvents include, without limitation, water (e.g., distilled water), ethanol, and ethylene glycol. In some cases, the choice of solvent can be based on the effect of the solvent on the metal precursor. For example, some alcohols can facilitate chemical reduction of metal ions associated with the metal precursor and hence speed up the metallization process. While in some applications, it might be desirable to utilize such alcohols as a solvent to speed up the metallization process, in other applications it might more desirable to use a solvent that does not substantially affect the chemical reduction of the precursor in absence of the applied radiation.

The applied mixture can then be cured, e.g., via a heat treatment, to form a polymeric layer 16 through which the metal ions are distributed (step B). For example, the mixture applied to the substrate surface can be cured by heating the mixture to an elevated temperature, e.g., by placing the substrate in an oven, for a selected time. For example, the mixture can be heated to a temperature in a range of about 40° C. to about 150° C., e.g., in a range of about 50° C. to about 100° C., for a time duration in a range of about 30 minutes to about 2 hours. The heating can cause the mixture to form a more viscous polymeric layer (e.g., a solid polymeric matrix) through which the metal ions are distributed.

In this exemplary embodiment, the cured polymeric matrix 16 is in the form of a film covering at least a portion of the substrate surface. The film can exhibit a variety of thicknesses. In some implementations, the film 16 can have a thickness in a range of about 0.5 microns to about 20 microns, e.g., 14 microns. Although the film 16 is shown as having a substantially uniform thickness, in other cases the film can have a non-uniform thickness. Further, in other cases, rather than forming a continuous film, the cured polymeric layer can be in the form of a plurality of separated polymeric portions disposed on the substrate surface (not shown).

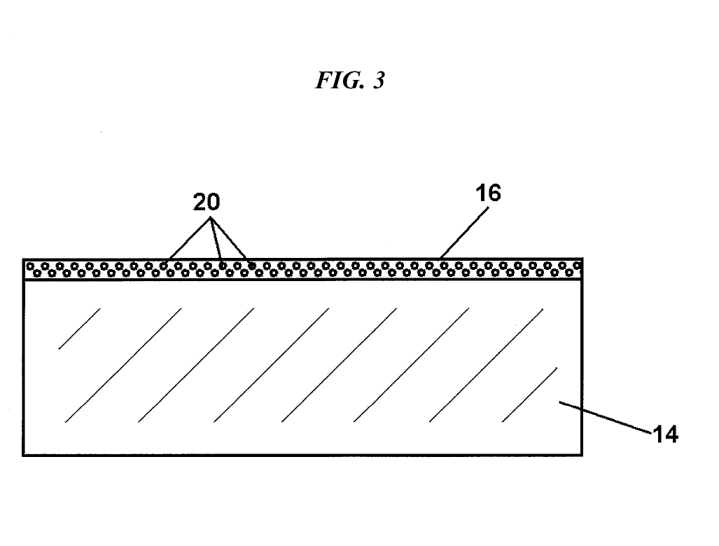

With continued reference to the flow chart of FIG. 1 as well as FIG. 2C, subsequently, in this exemplary embodiment, a plurality of radiation pulses at a wavelength to which the polymeric film 16 is substantially transparent can be focused into a plurality of three-dimensional locations 18 within the polymeric film 16 to selectively cause chemical reduction of the metal ions in at least a portion of those locations (step C). The reduction of the metal ions associated with the metal precursor generates metalized regions within those locations, as shown schematically by the regions 20 in FIG. 3.

For example, in some embodiments, short laser pulses can be tightly focused into a focal volume of the cured mixture (e.g., a polymeric matrix) such that multiple photons converge in time and space to collectively bridge an electronic energy gap of at least one constituent of the cured mixture to cause reduction of at least a portion of the metal ions.

More specifically, in this illustrative embodiment, although the polymeric film is substantially transparent to the applied radiation so that the radiation can readily penetrate into a depth of the film, the focusing of the radiation causes the radiation intensity to be sufficiently high within at least a portion of each of the locations 18 (e.g., corresponding to the focal volume of the focused radiation) such that non-linear absorption of the radiation by one or more constituents of the polymeric film can occur. By way of example, such non-linear absorption can include multi-photon (e.g., two-photon, three-photon, or four-photon) absorption of the radiation, e.g., at the focal volume. By way of example, the radiation fluence at the focal volume can be as small as about 20.7 J/m², or smaller (e.g., 0.5 J/m²).

Without being limited by any particular theory, the non-linear absorption of the radiation by one or more constituents of the polymeric film (e.g., solvent such as water) can mediate the chemical reduction of the metal precursor. Again, without being limited to any particular theory, multi-photon absorption of the radiation by the solvent or a moiety of the polymeric mixture can cause electronic excitation of the solvent or that moiety into one or more excited electronic states. A charge transfer between one or more of these excited electronic states and the metal precursor can cause chemical reduction of the metal precursor.

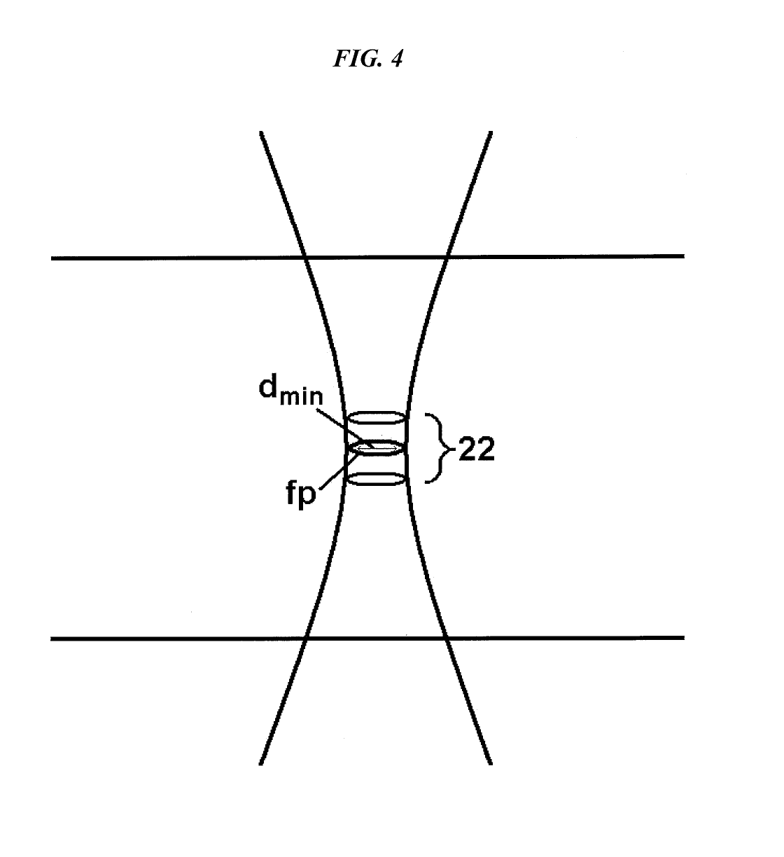

By way of further illustration, FIG. 4 schematically shows that, in some embodiments, as a focused radiation beam penetrates the polymeric film, its beam waist continues to decrease until it reaches a minimum diameter (dₘᵢₙ) in a focal plane (fp). The intensity of the radiation within a volume (e.g., focal volume 22) surrounding the focal plane can be sufficiently high so as to lead to the non-linear absorption of the radiation in that volume, thereby resulting in the chemical reduction of the metal ions in that volume. This allows selectively metalizing desired three-dimensional portions of the polymeric film. By way of example, when the metal precursor is silver nitrate (AgNO₃), the reducing reaction can lead to formation of silver structures (e.g., crystalline silver regions), e.g., within the focal volume of the focused radiation.

The three-dimensional metalized structures can be separated from one another, i.e., they can be in the form of disconnected metalized regions 20 as shown schematically in FIG. 3. The polymeric matrix can exhibit sufficient structural stability to maintain the disconnected metal structures (voxels) in place. Further, in many cases, the polymeric matrix can exhibit a high degree of chemical stability to significantly slow down sample degradation with time. In some cases, such metalized structures (regions) can have a size in at least one dimension, and in some cases in each of three dimensions (e.g., x, y, z Cartesian dimensions), that is less than about 2 microns, e.g., in a range of about 150 nm to about 1 micron.

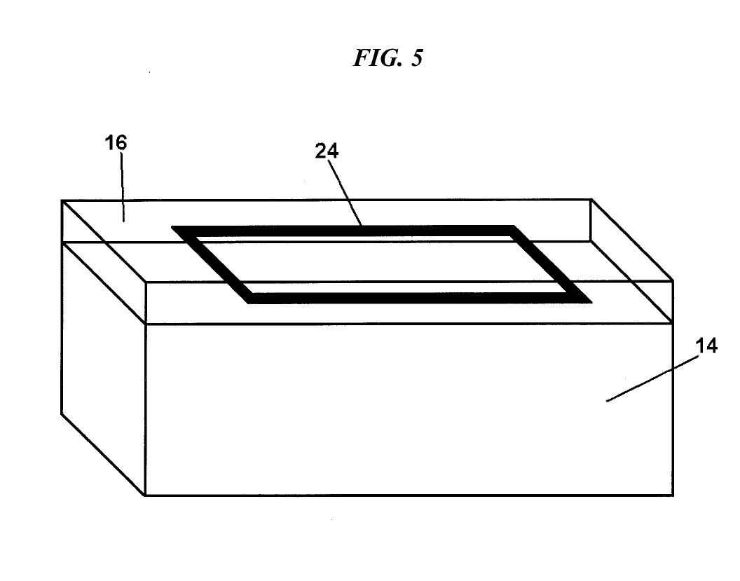

Alternatively, at least some of the metalized regions can have a partial overlap with one another to collectively generate interconnected structures (e.g., by scanning a radiation beam (radiation pulses) over an extent of the polymeric film). In some cases, a network 24 of interconnected metalized regions can be formed by practicing the methods of the invention, as shown schematically in FIG. 5.

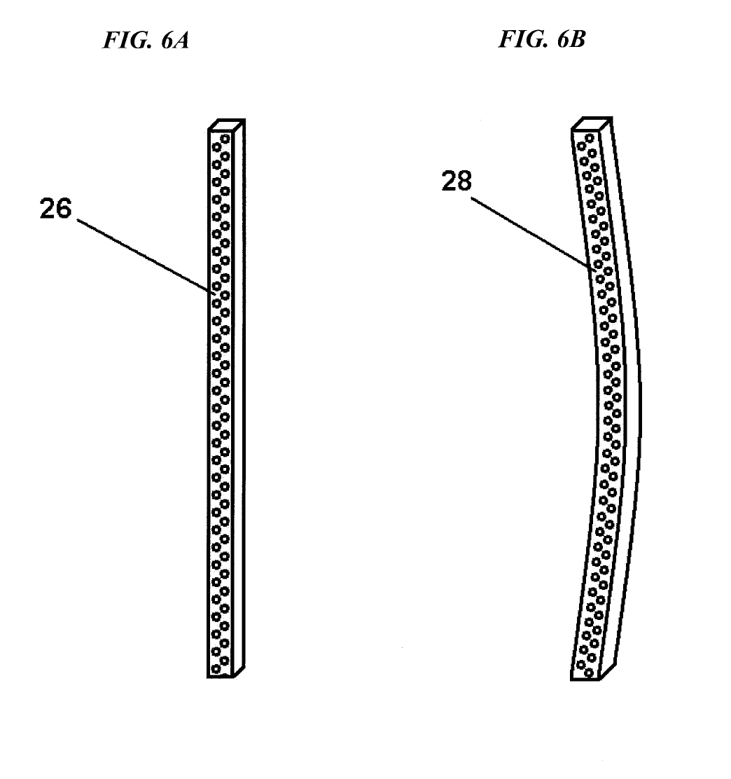

Referring again to FIG. 3, in some embodiments, the polymeric matrix having one or more metallic structures 20 distributed therein can be removed from the underlying substrate 14 to provide a stand-alone metalized polymeric substrate 26, as shown schematically in FIG. 6A. In many embodiments, such a polymeric substrate having a plurality of metallic structures distributed therein can exhibit mechanical flexibility, e.g., as shown schematically in FIG. 6B by the bent substrate 28. Such mechanical flexibility can be useful in a variety of applications. By way of example, such flexible metalized polymeric matrix can be employed to fabricate flexible biological sensors, flexible photovoltaics, flexible chemical sensors, flexible integrated optical devices, flexible metamaterials, and flexible integrated electrical devices. In some cases, prior to application of the polymeric mixture to the substrate (the above step A), a layer of silane can be deposited on the substrate surface to facilitate subsequent removal of the polymeric matrix from the substrate. In some cases, the wetting properties of the substrate can be selected such that the polymer matrix formed during the curing step separates from the substrate surface. For example, a polymeric mixture can also be used in conjunction with a substrate that does not wet with the solvent (or solution) used in the mixture.

The above processes for selective metallization of a polymeric substrate (e.g., a polymeric film) provide a number of advantages. For example, they allow selective metallization of three-dimensional volumes (voxels) within the polymeric film. In particular, the metallization occurs selectively in volume portions in which the intensity of the applied radiation is sufficiently high to result in non-linear absorption.

The methods of invention for fabricating metalized structures (e.g., micro and nano-sized metal structures), and the resultant metalized polymeric substrates, can find a variety of applications. Some examples of such applications include, without limitation, metamaterials, metal materials, antennae, biological sensors, chemical sensors, photovoltaics, lasers, and integrated optical devices, among others.

In some embodiments, the methods of the invention utilize a mixture of chemical reagents that allow generating a support matrix, e.g., a polymer matrix, for the metal structures to be generated via application of the laser pulses while ensuring that reduction of the metal ions in regions of the support matrix not illuminated by the laser pulses does not occur, or at least occurs very slowly, for example, over a period of weeks, months or years.

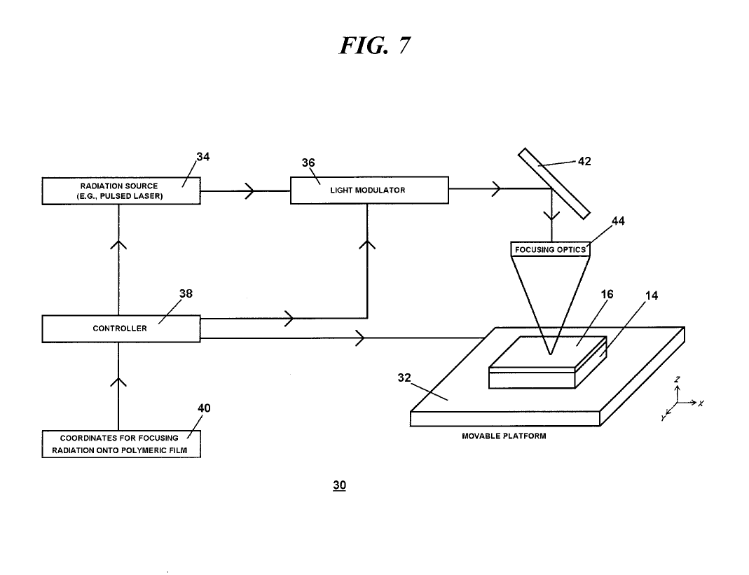

FIG. 7 schematically depicts a system 30 that can be employed to perform metallization methods according to the teachings of the invention. The exemplary system 30 includes a translation platform 32 on which a substrate, e.g., the above substrate 14 on which the polymeric film 16 is disposed, can be mounted. As discussed in more detail below, the translation platform 32 can be moved in three orthogonal directions (e.g., x, y, z Cartesian directions) so as to allow delivering radiation to selected portions of the polymeric film.

The system 30 further includes a radiation source 34, which in this implementation can be a laser. For example, the radiation source can be an unamplified Ti:Sapphire laser system that can generate laser pulses with a pulse width, e.g., in a range of about 50 fs to about 800 fs, a pulse energy, e.g., in a range of about 5 nJ to about 100 nJ, at a central wavelength of 800 nm. In some implementations, the Ti:Sapphire laser system can generate laser pulses at a repetition rate in a range of about 1 MHz to about 90 MHz, e.g., 11 MHz (as discussed below, in many embodiments, a modulator is employed to apply pulses to the polymeric layer at a lower repetition rate). In many embodiments, the radiation pulses generated by the source can be attenuated (e.g., by employing a neutral density filter (not shown)) such that the energy of the pulses applied to the polymeric matrix is in a range of about 0.05 nJ to about 40 nJ, e.g., in a range of about 0.07 nJ to about 20 nJ. For more details on femtosecond laser systems, see, for example, U.S. Pat. No. 7,568,365 entitled “Method and Apparatus for Micromachining Bulk Transparent Materials Using Localized Heating by Nonlinearly Absorbed Laser Radiation, and Devices Fabricated Thereby,” which is herein incorporated by reference in its entirety.

A radiation modulator 36, e.g., a mechanical, electro-optic, or acousto-optic modulator, receives the radiation generated by the radiation source 34, e.g., the radiation pulses generated by the Ti:Sapphire laser. The radiation modulator 36 can function as a shutter under the control of a controller 38 to ensure that selected locations within the polymeric film 16 are exposed to the radiation. In some cases, the repetition rate of the pulses leaving the modulator to be applied to the polymeric matrix can be in a range of about 1 kHz to about 1 MHz, e.g., about 500 kHz.

More specifically, the controller 38 can move the platform 32, and consequently the substrate 14 mounted thereon based on, e.g., a set of predetermined coordinates 40 identifying a plurality of locations within the polymeric film 16. Further, the controller 38 can provide control signals to the radiation source 34 (e.g., to trigger the radiation source to generate radiation pulses—though such triggering is not always needed) and to the radiation modulator 36 to ensure that radiation is directed to the selected locations within the polymeric film 16. For example, the controller 38 can control the light modulator 36 so that each selected location would receive a desired number of radiation pulses.

The radiation leaving the modulator 36 is reflected by a mirror 42 (which can comprise multiple mirrors and other optical elements known in the art) to focusing optics 44, which in turn focuses the radiation onto the selected locations within the polymeric film 16. The focusing optics 44 can include one or more refractive and/or reflective elements, such as a compound objective lens, an aspheric lens, a parabolic reflector, and other suitable optical elements known in the art. The focusing optics 44 provide sufficient focusing of the radiation (e.g., characterized by the numerical aperture of the focused radiation) such that the laser intensity at the selected locations (which typically encompass the focal volume of the focused radiation) is sufficiently high to cause non-linear absorption of the radiation by one or more constituents of the polymeric film 16. In some implementations, the system can also include a microscope (not shown) for in-situ monitoring of the polymeric film during laser processing.

As discussed above, such non-linear absorption of the radiation in each location can facilitate chemical reduction of the metal precursor (e.g., by facilitating charge transfer processes) so as to form a metalized region (e.g., a region containing crystalline form of the metal) within at least a portion of that location.

Further, as discussed above, the selected locations can be separated from one another so as to form disjointed metalized regions (that is, metalized regions that are separated from one another by portions of the polymeric film that are not treated by the radiation). In other cases, the locations onto which the radiation is focused are chosen such that at least some of the metalized regions are overlapping, e.g., to form an extended structure, such as a line.

As discussed above, the methods of the invention for patterning metals at the micro- and nano-scales find a variety of applications from microelectronics to optics to biosensors, to name a few. For example, as discussed above, the methods of the invention allow fabricating 3D disconnected metal nanostructures in a dielectric matrix via multiphoton absorption of short laser pulses, which can find a variety of applications.

The following Examples further illustrates the salient aspects of the invention. The Examples are provided only for illustrative purposes and are not intended to necessarily indicate the optimal ways of practicing the invention or optimal results that can be obtained.

### Example 1

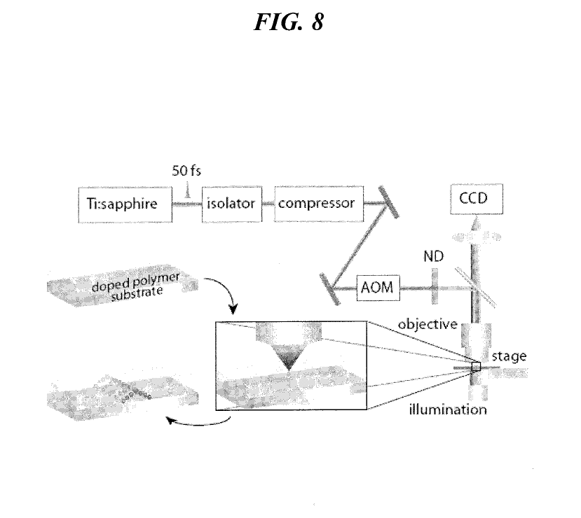

The system schematically shown in FIG. 8 was employed to selectively induce metal-ion photoreduction in the metal-doped polymer matrix. An objective with a numerical aperture (NA) of 0.8 was used to focus a plurality of laser pulses from a Ti:sapphire laser (795-nm center wavelength, 11-MHz repetition rate, 50-fs pulse duration) into the polymer matrix. The exposure was controlled by an acousto-optic modulator. A high-precision translation stage was employed to select the region that was exposed to the laser pulses. Without being limited to a particular theory, at the focus, nonlinear light-matter interactions induce metal-ion photoreduction processes in a volume smaller than the diffraction-limited focal spot, initiating silver nanoparticle growth.

An aqueous polymeric solution of PVP, AgNO₃ was prepared in a vial by dissolving 0.206 grams (g) of PVP into 8 milliliters (ml) of distilled water followed by adding 0.21 g of AgNO₃. Care was taken (via aluminum foil shielding) to prevent ambient UV light from initiating a chemical reduction reaction in the polymeric solution. The polymeric solution was kept in a refrigerator for use in the subsequent stages discussed below. The refrigerator advantageously inhibits the chemical reduction of the solution.

A plasma-treated surface of a glass substrate was silanized with APMS (Acryloxy propyl methoxy silane). The silanization can allow better adhesion of the polymeric matrix to be produced in subsequent processing steps onto the glass substrate.

The polymeric solution was removed from the refrigerator and one milliliter of the solution was poured onto the silanized glass surface to generate a polymeric film having a thickness of about 1.5 mm.

The glass substrate coated with the polymeric solution was then cured (baked) by placing it in an oven and maintaining it at a temperature of about 55° C. for about 2 hours. The curing step causes a reduction of the thickness of the film to tens of micrometers.

Subsequently, a Ti:Sapphire laser was employed to produce laser pulses having a 50 fs pulsewidth, a central wavelength of 800 nm, and the laser pulses were focused into selected locations of the polymeric film. A numerical aperture (NA) of 0.8 was employed for focusing the laser beam onto the film.

An acousto-optic modulator (AOM) was utilized to “shutter” the laser beam on and off using software and hardware control. In particular, the acousto-optic modulator was employed to control the number of laser pulses applied to the polymeric film and to control the energy deposition into the film. Pulse trains, composed of pulses separated by approximately 91 ns, that were 2 microseconds long and temporally separated by about 4 microseconds were applied to the polymeric film. That is, the modulator had a repetition rate of 166 kHz and a duty cycle of 2 microseconds.

The energy of each pulse was about 0.3 nJ and it was focused over an area of approximately 2 microns in diameter at the focal plane. The AOM was used to adjust the number of pulses arriving at the polymeric film.

The polymeric-coated substrate was translated at a rate of 10 micrometer/second during laser exposure. The depth adjustment was achieved by moving the translation stage in a direction perpendicular to the plane of the polymer film (z-direction).

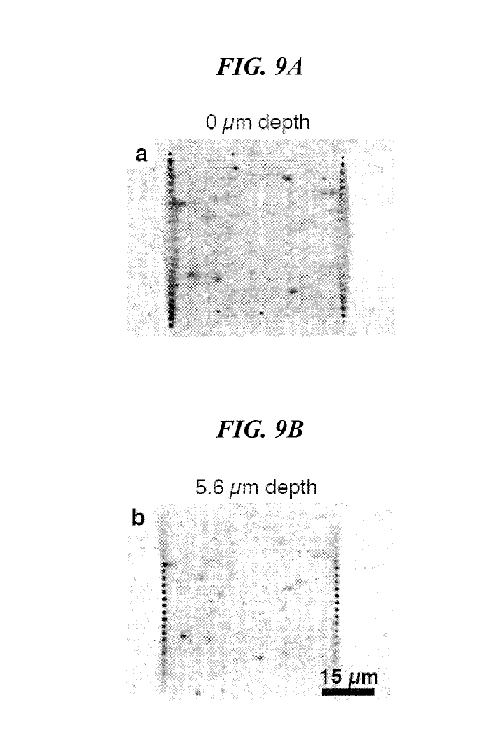

FIGS. 9A and 9B depict optical microscope images of the film showing metalized (darker) regions. The images shown in FIGS. 9A and 9B were taken with different focal lengths, illustrating disconnected metalized regions in different planes in a direction normal to the film. From the leftmost side of the pattern to the rightmost side of the pattern, the distance is about 50 micrometers in each image. The feature sizes of the metallic structures are estimated to be submicron.

Energy-dispersive X-ray spectroscopy (commonly referred to as EDS or EDX) was employed for elemental analysis of the sample. As known in the art, EDS is an analytical technique that can be used for chemical characterization (elemental analysis) of a sample. As known in the art, in EDS, a sample is exposed to a high energy beam of charged particles (e.g., electrons or protons). The incident beam can cause electronic excitation of various elements of the sample, e.g., by exciting electrons from an inner shell to create a hole in that shell. An electron from an outer shell can then fill the hole and release X-ray energy equal to the energy difference between the two shells. The energy of the emitted X-ray depends on the energy difference between the two shells, which is a characteristic of a particular element. Thus, the energy spectrum of the emitted X-ray radiation can be analyzed to determine elemental composition of the sample. The spectrometer employed was Zeiss EVO 55 Environmental SEM with EDAX EDS detector.

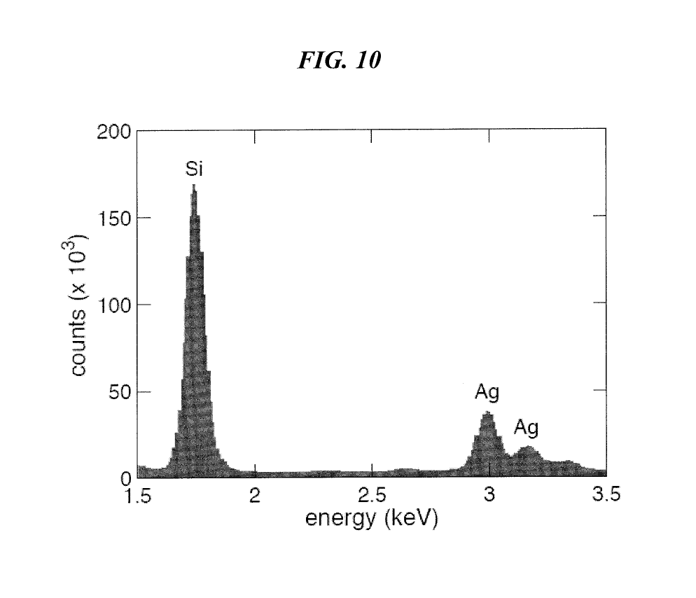

FIG. 10 shows an EDS spectrum of the above polymeric-coated substrate after its exposure to the laser pulses. The polymer was washed off to perform two-dimensional (2D) analysis of the sample. The Ag peak indicates that silver structures were generated within the polymeric film. The Si peak is from the glass substrate. The other peaks are from various trace dopants in the glass substrate. The carbon peak can be from a glass dopant or a trace amount left over from the polymer.

Thus, a pattern of disconnected 3D metallic structures were observed.

### Example 2

A solution of AgNO₃, PVP and H₂O was coated onto a glass substrate, whose surface was silanized with Mercapto Propyl Trimethoxy Silane, through a drop casting technique and the coated substrate was baked to create a polymer matrix doped with silver ions. The system shown in FIG. 8 was employed to selectively induce metal-ion photoreduction in the metal-doped polymer matrix. An objective with a numerical aperture (NA) of 0.8 was used to focus a plurality of laser pulses from a Ti:sapphire laser (795-nm center wavelength, 11-MHz repetition rate, 50-fs pulse duration) into the polymer matrix. The exposure was controlled by an acousto-optic modulator. A high-precision translation stage was employed to select the region that was exposed to the laser pulses. Without being limited to a particular theory, at the focus, nonlinear light-matter interactions induce metal-ion photoreduction processes in a volume smaller than the diffraction-limited focal spot, initiating silver nanoparticle growth.

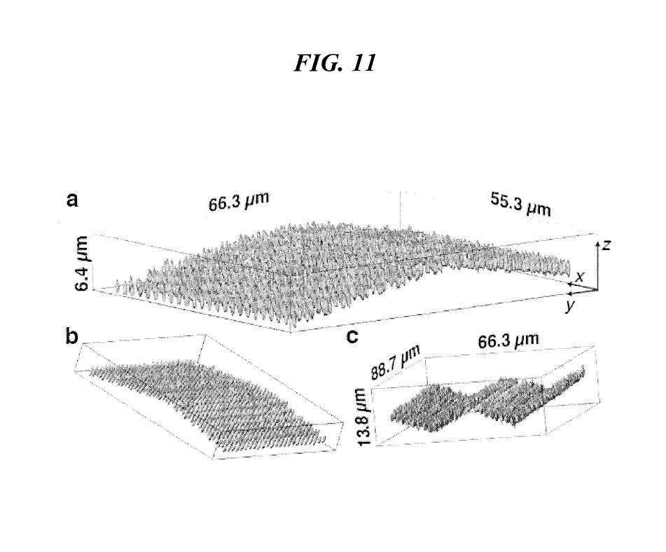

By varying the laser parameters, the size of the resulting silver structures could be adjusted. At an exposure of 1.3×10⁶ pulses per voxel with 0.15 nJ per pulse, the structures can be resolved by optical imaging. FIGS. 11A-11C show 3D renderings of a stack of sequential 2D in-situ bright-field optical images of such generated silver structures. The images highlight the disclosed methods allow direct-writing silver structures that are disconnected in 3D inside a polymer.

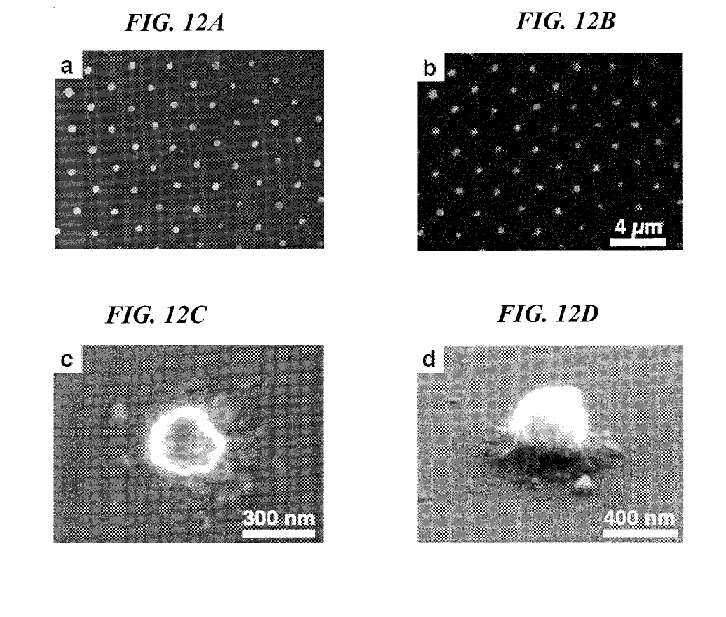

Reducing the laser exposure to 2.8×10⁵ pulses per voxel with 0.2 nJ per pulse resulted in decreasing the size of the silver features to submicrometer scales (less than about 300 nm—See FIGS. 12A-12D). At the operating wavelength of 795 nm, the transverse resolution of the overfilled microscope objective is approximately 600 nm—about twice the size of the fabricated nanostructures. Unlike most multiphoton absorption lithography techniques that use oil immersion objectives to achieve a high resolution, these results were obtained at a numerical aperture of 0.8. Although higher-NA objectives have a smaller focal volume, the primary advantage of a lower-NA objective is the longer working distance (3 mm), which is useful for bulk 3D nanolithography. In addition to enabling 3D disconnected nanostructure fabrication, the process used to generate the silver nanostructures is approximately two orders of magnitude faster than other 3D direct-write techniques with similar resolution. For example, in the present process a write-speed of 100 μm/s. can be achieved using an 11-MHz laser.

To determine the constituent elements in the direct written features, high-resolution energy dispersion x-ray spectroscopy (EDS) and scanning electron microscopy (SEM) were employed. FIG. 12A shows SEM images of an array of silver dots fabricated on a glass substrate, and FIG. 12B shows the fabricated array and its corresponding high-resolution EDS silver elemental map, confirming that the fabricated dots contain silver. FIG. 12C shows a close-up view of an individual silver dot head-on and FIG. 12D shows a close-up view of an individual silver dot at a 61° tilt angle.

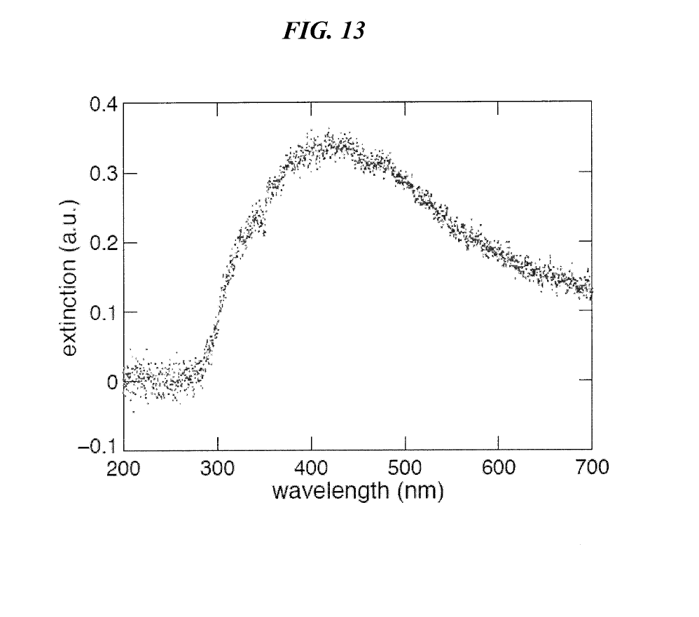

The presence of silver was corroborated by a strong silver signal in the EDS spectrum. Ultraviolet and visible micro-absorption and scattering spectroscopy showed a characteristic silver surface plasmon peak centered around 425 nm, as shown in FIG. 13. The broad extinction spectrum indicated polydispersity of the silver nanoparticle size.

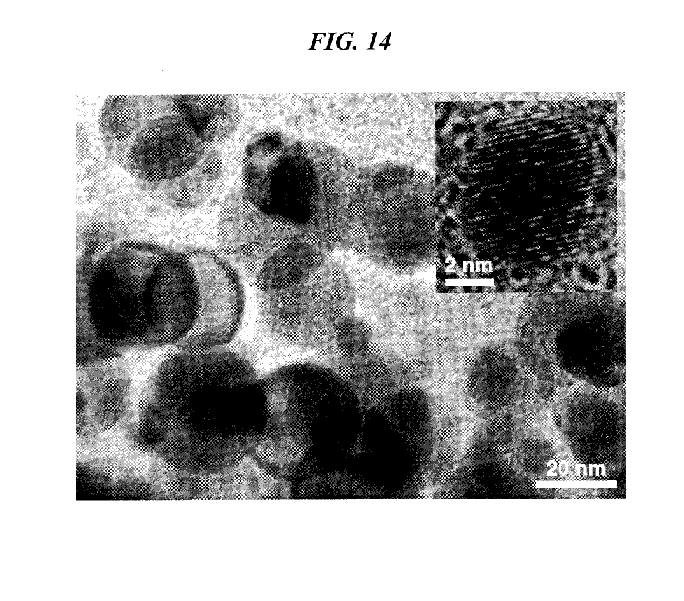

Further characterization through transmission electron microscopy (TEM) (See FIG. 14) confirms that the silver did not grow as a single crystal in each irradiated voxel; rather structures are composed of agglomerations of smaller silver nanoparticles. The inset of FIG. 14 is a higher magnification image of a silver nanoparticle created during the fabrication process.

As noted above, in the process utilized to generate the aforementioned silver features, PVP was dissolved in H₂O, minimizing reduction reactions outside the laser-irradiated volume. The use of PVP with H₂O in absence of alcohol in the process for generating the silver features discussed in this example can provide both a support matrix and a controlled growth of the silver structures. In particular, without being limited to any particular theory, the omission of the alcohol solvent can significantly decrease, or eliminate, the reduction of Ag⁺ ions in the portions of the polymer that are not exposed to laser radiation, thereby enhancing spatially selective generation of the silver structures. Again, without being limited to any particular theory, the strong affinity of N and O atoms in the amide groups of PVP to surfaces of transition metal clusters can restrain their growth.

Those having ordinary skill in the art will appreciate that various changes can be made to the above exemplary embodiments without departing from the scope of the invention.

1. A method of generating metal structures, comprising:
providing a mixture of a compound, a metal precursor, and a solvent,
applying the mixture to a surface of a substrate,
curing the applied mixture to generate a cured mixture, and
focusing radiation onto at least one location of the cured mixture so as to form at least one metal structure within at least a portion of said location.

2. The method of claim 1, wherein said cured mixture comprises a plurality of metal ions associated with said metal precursor.

3. The method of claim 2, wherein said step of focusing radiation causes reduction of at least a portion of said metal ions within said at least portion of said location so as to form said metal structure.

4. The method of claim 3, wherein said focused radiation has a sufficiently high intensity at said location so as to undergo non-linear absorption by at least one radiation-absorbing constituent of said cured mixture, thereby mediating the chemical reduction of the metal ions.

5. The method of claim 1, wherein said compound comprises any of at least one polymer, or at least one monomer.

6. (canceled)

7. The method of claim 1, wherein said curing step increases a viscosity of said mixture.

8. The method of claim 1, wherein said curing step generates a polymeric layer over the substrate surface.

9. The method of claim 6, wherein said curing step causes said at least one monomer to generate a polymeric layer over the substrate surface.

10. The method of claim 1, wherein said curing step causes a portion of metal ions associated with said metal precursor to form metallic nanoparticles.

11. The method of claim 10, wherein said nanoparticles have a size in each dimension less than about 100 nanometers.

12. The method of claim 10, wherein said metal nanoparticles have a size in each dimension in a range of about 2 nanometers to about 20 nanometers.

13. The method of claim 1, wherein the radiation has a wavelength to which the cured mixture is substantially transparent.

14. The method of claim 1, wherein said radiation comprises a plurality of radiation pulses having a pulsewidth in a range of about 5 fs to about 100 ns.

15. The method of claim 1, wherein said radiation pulses have a pulsewidth in a range of about 5 fs to about 1 picosecond.

16. The method of claim 1, wherein said radiation pulses have a pulsewidth in a range of about 5 fs to about 500 fs.

17. The method of claim 1, wherein said radiation has a wavelength in a range of about 500 nm to about 1200 nm.

18. The method of claim 12, wherein said radiation pulses have an energy in a range of about 0.05 nJ to about 20 nJ.

19. The method of claim 12, wherein a number of said radiation pluses applied to said at least one location of the polymeric layer is in a range of about 1 to about 500.

20. The method of claim 1, wherein said radiation pulses are focused into said cured mixture with a numerical aperture in a range of about 0.4 to about 1.5.

21. The method of claim 1, wherein said metal precursor comprises a metal salt.

22. The method of claim 1, wherein said metal precursor is any of AgNO₃, AgClO₄, AgBF₄ and HAuCl₄.

23. The method of claim 1, wherein said mixture further comprises a plurality of metal nanoparticles.

24. The method of claim 23, wherein said metal nanoparticles have a size in each dimension less than about 100 nm.

25. The method of claim 24, wherein said metal nanoparticles have a size in each dimension in a range of about 5 nm to about 20 nm.

26. The method of claim 24, wherein said metal nanoparticles have a size in each dimension in a range of about 5 nm to about 10 nm.

27. The method of claim 3, wherein said reduction of the metal ions results in the formation of a crystalline metallic region.

28. The method of claim 5, wherein said polymer is any of polyvinyl pyrrolidone, polyvinyl alcohol, polyvinyl carbazole, polymethylmethacrylate, and polystyrene.

29. The method of claim 1, wherein said solvent comprises any of water and an alcohol.

30. The method of claim 29, wherein said alcohol comprises any of ethanol and ethylene glycol.

31. The method of claim 1, wherein said metalized structure is a three-dimensional structure.

32. The method of claim 1, wherein the step of curing the mixture comprises heating the mixture to an elevated temperature.

33. The method of claim 32, wherein said elevated temperature is in a range of about 40° C. to about 150° C.

34. The method of claim 33, further comprising maintaining the mixture at said elevated temperature for a time duration in a range of about 30 minutes to about 24 hours.

35. The method of claim 31, wherein said three-dimensional metalized structure has a size in at least one dimension in a range of about 150 nm to about 5 microns.

36. The method of claim 31, wherein said three-dimensional metalized structure has a size in each of its three dimensions in a range of about 150 nm to about 5 microns.

37. The method of claim 1, wherein said at least one location comprises a plurality of locations distributed within said cured mixture.

38. The method of claim 37, wherein said plurality of metalized structures generated in said plurality of locations are separated from one another by unmetalized portions of said cured mixture.

39. The method of claim 37, wherein said metalized structures are distributed within said cured mixture according to a predefined pattern.

40. The method of claim 1, wherein said substrate is any of a glass substrate, a polymer substrate, and a semiconductor substrate.

41. The method of claim 1, wherein said substrate surface is exposed to a plasma prior to application of the mixture thereto.

42. The method of claim 41, wherein said substrate surface is silanized after exposure to the plasma.

43. The method of claim 1, wherein said mixture is any of a solution and a colloid.

44. The method of claim 1, wherein said solvent comprises water and said compound comprises a polymer.

45. The method of claim 44, wherein said mixture is free of a constituent capable of reducing metal ions associated with the metal precursor in absence of said radiation.

46. The method of claim 44, wherein said mixture is free of any alcohol.

47. The method of claim 46, wherein said polymer comprises polyvinyl pyrrolidone.

48. A method of generating metal structures, comprising:
generating a polymeric matrix having a plurality of metal ions distributed therein,
focusing at least one radiation pulse onto at least one location of the polymeric matrix so as to cause at least a portion of the metal ions within said location to form one or more metal structures.

49. The method of claim 48, wherein said one or more radiation pulses cause reduction of said at least a portion of the metal ions so as to form said one or more metal structures.

50. The method of claim 48, wherein said step of generating the polymeric matrix comprises:
generating a mixture of a polymer, a metal precursor and a solvent, and
curing the mixture so as to generate the polymeric matrix.

51. The method of claim 49, wherein said at least one focused radiation pulse has a sufficiently high intensity within said location so as to undergo non-linear absorption by at least one radiation-absorbing constituent of the said polymeric matrix, thereby mediating reduction of said at least a portion of the metal ions.

52. The method of claim 50, wherein said polymer is any of polyvinyl pyrrolidone, polyvinyl alcohol, polyvinyl carbazole, polymethylmethacrylate, and polystyrene.

53. The method of claim 50, wherein said polymeric matrix is free of a constituent capable of reducing said metal ions in absence of said radiation pulses.

54. The method of claim 48, wherein said polymeric matrix is free of an alcohol constituent.

55. The method of claim 48, wherein said radiation pulses have a pulsewidth in a range of about 5 fs to about 100 ns.

56. The method of claim 48, wherein said radiation pulses have a central wavelength to which the polymeric matrix is substantially transparent in absence of non-linear absorption.

57. The method of claim 48, wherein said radiation pulses have a fluence in a range of about 5 J/m² to about 500 J/m² in said at least one location.

58. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)
